(19) United States
(12) Patent Application Publication
(10) Pub. No.: US 2004/0109793 A1
(43) Pub. Date: Jun. 10, 2004

(54) Three-dimensional microfluidics incorporating passive fluid control structures

(76) Inventors: Michael R McNeely, Sandy, UT (US); Mark Spute, Salt Lake City, UT (US); Nils Adey, Salt Lake City, UT (US)

Correspondence Address: Madson & Metcalf, Suite 900, 15 West South Temple, Salt Lake City, UT, 84101, US

(21) Appl. No.: 10/467,585

(22) PCT Filed: Feb. 7, 2002
(86) PCT No.: PCT/US02/04045

(51) Int. Cl. B01L 3/00

(52) U.S. Cl. 422/100

(57) ABSTRACT

A three-dimensional microfluidic device (100) formed from a plurality of substantially planar layers (101, 102, 103) sealed together is disclosed

### RELATED APPLICATIONS

In the United States, this application is a Continuation-in-Part of U.S. patent application Ser. No. 09/967,402, filed Sep. 28, 2001, which is a continuation of U.S. patent application Ser. No. 09/417,691, filed Oct. 13, 1999, now issued as U.S. Pat. No. 6,296,020 on Oct. 2, 2001, which claimed priority to U.S. Provisional Application 60/103,970 filed Oct. 13, 1998 and U.S. Provisional Application 60/138,092 filed Jun. 8, 1999.

This application, also claims the benefit of:

U.S. Provisional Application No. 60/267,154 filed on Feb. 7, 2001

U.S. Provisional Application No. 60/274,389 filed Mar. 9, 2001;

U.S. Provisional Application No. 60/284,427 filed Apr. 17, 2001;

U.S. Provisional Application No. 60/290,209 filed May 11, 2001;

U.S. Provisional Application No. 60/313,703 filed Aug. 20, 2001;

U.S. Provisional Application No. 60/339,851 filed Dec. 12, 2001;

U.S. patent application Ser. No. 09/855,870, filed May 15, 2001, which claims priority to U.S. Provisional Application 60/204,306, filed May 15, 2000;

U.S. patent application Ser. No. 09/922,451, filed Aug. 3, 2001, which claims priority to U.S. Provisional Application 60/223,022, filed Aug. 4, 2000; and

U.S. patent application Ser. No. 10/009,674, which claims priority to PCT/US00/40156 filed Jun. 8, 2000, which claimed priority to U.S. Provisional 60/138,091 filed Jun. 8, 1999; each of which is incorporated herein by reference.

### FIELD OF THE INVENTION

The present invention relates generally to the field of microfluidics, and particularly to three-dimensional microfluidic circuits formed in multi-layered structures. More specifically, the present invention related to three-dimensional microfluidic devices incorporating passive fluid control elements.

### DESCRIPTION OF RELATED ART

Integrated Circuits and Micro-Electro Mechanical Systems (MEMS) are made using microfabrication processes such as micro-lithography, chemical etching; and thin film deposition, typically on silicon substrates. Micro fluid analysis, or microfluidics, is a sub-set of MEMS in which microscale fluid handling structures are constructed, frequently for use in the processing and/or analysis of liquid bio-chemical samples. Although microfluidic structures were first fabricated in silicon, a large percentage of microfluidic devices are now constructed in plastic, while others are formed in glass. Conventional microfabrication techniques are utilized, as well as new or modified methods of hot embossing and micro-injection molding. Laser machining is also performed, using both IR and UV lasers, to form microfluidic structures in substrates.

Most microfluidic systems are 2 or 2½-D, meaning they are made up of microfluidic structures such as channels or wells that lie a single plane. While microfluidic structures in 2 or 2½-D systems have depths, which may vary somewhat from structure to structure, the structures do not vary significantly in elevation with respect to each other, nor does one structure ever cross over or overlap another structure. 2 or 2½-D systems are prevalent for the simple reason that open channels or wells can be readily formed in a surface of a bulk substrate, and subsequently enclosed by covering the surface of the substrate with a cover plate or film; since substrate surfaces are typically planar, this approach results in the formation of a substantially planar enclosed microfluidic circuit. In contrast, to form structures that overlap or have varying altitudes in a bulk substrate, it is necessary to form at least one of the structures in the interior of the bulk substrate, which is considerably more difficult than forming surface structures.

In some applications, particuiarly those involving multiple fluid processing circuits operating in parallel, having numerous inlets and outlets, or having circuits supplied with multiple samples or reagents, it is impossible to form the required microfluidic circuit in a single plane because portions of the circuit must cross over or overlap other portions of the circuit. In other cases, it may be theoretically possible to form a particular microfluidic circuit in a single layer, but undesirable from a practical standpoint because the size of the device and the length of the microfluidic channels would have to be too large. Indeed, although from a theoretical standpoint it should be topologically possible to form any microfluidic circuit in two layers (Anderson et al.), in many cases even a two-layer device may be undesirable from a practical standpoint for the reasons noted above. Because of the foregoing, there has been considerable recent effort toward the development of a workable method of constructing multi-layered, or three-dimensional microfluidic devices.

The most common approach that has been taken for forming three-dimensional microfluidic circuits is to form 2 or 2½-D microfluidic structures in multiple planar layers and then connect the layers together to form a three-dimensional structure, using vias or connecting channels to deliver fluid from circuits in one layer to circuits in other layers. By forming multi-layered structures it is possible to maintain the relative ease of fabricating microfluidic structures in the surface of the substrate material, while offering the flexibility of forming devices having a theoretically unlimited number of layers.

Published PCT application WO 01/41931 describes the formation of multi-layered microfluidic structures by laminating and then sintering ceramic sheets that have channels or other microfluidic structures formed in them. Published PCT application WO 01/25138 discloses a multi-layered microfluidic structure formed by laminating together layers of self-adhesive plastic tape. In both these methods, microfluidic channels (or other structures) pass all the way through the relatively thin sheet material, so that the sides of a channel are formed by the layer in which the channel is formed, while the top and bottom of the channel are formed by adjacent layers.

The use of microfabrication techniques for forming structures in a silicon substrate, which are then used as molds for forming polymeric layers or membranes containing microfluidic structures has been described (Anderson et al., also WO 01/89788, WO 01/89787). Another approach that has been described is the formation of metal traces defining microfluidic structures on printed circuit board substrates, which may then be stacked to form three-dimensional fluid circuits, or which may serve as mold masters for polymeric replicas that can be stacked to form three-dimensional structures (WO 01/25137).

The fabrication of monolithic devices having overlapping channel structures by photoresist and etching techniques established in semiconductor industry and adapted for use in MEMS has also been described in U.S. Pat. No. 6,033,544, issued Mar. 7, 2000.

In practice, 3-dimensional or multi-layer microfluidic systems are more complicated, more expensive, and more prone to failure than 2-D or single layer systems. The major complications in the fabrication of multi-layered microfluidic systems arise in the alignment and sealing of the various layers together. Large geometry systems, where the features may be on the order of 1 mm or more, present fewer problems with regard to alignment However, in systems with very small features, particularly small connecting vias on the order of 100 μm or less, alignment is a considerable problem.

Providing a leak-free seal between multiple layers remains a challenge. The sealing method of choice depends upon the particular substrate material(s) used. Sealing methods include eutectic or anodic bonding, the use of adhesives or epoxies, or ultrasonic welding. Silicon, glass, ceramics, and most plastics used in the construction of microfluidic devices are hydrophilic by nature. Because hydrophilic capillarity generates strong forces that are inversely proportional to the size of the feature, aqueous fluids tend to flow into small gaps in hydrophilic structures. Therefore, it is particularly important to produce gap-free sealing between layers in hydrophilic multi-layer systems. In some cases it would be desirable to have a releasable seal between certain layers of multi-layer devices, so that devices could be disassembled, for example to permit certain portions of the device to be disposable and other portions to be reusable, or to permit washing or sterilization of certain portions of the device. The challenge then becomes finding an adhesive that forms an effective seal, and that can also be released when desired, but not before.

Controlling the movement of fluids within a microfluidic device is an essential aspect of virtually any microfluidic device, but is more difficult to implement in more complex microfluidic circuits. In microfluidic systems that utilize electro-kinetic or electro-hydrodynamic fluid control, large numbers of electrodes attached to flow channels may be required for complex microfluidic circuits. Other microfluidic systems use pressure-driven flow, usually in combination with some type of valving to modulate flow of fluids within the device. Valves may also be used in devices that utilize electro-kinetic or electro-hydrodynamic fluid control. Various types of active and passive microvalves have been described for use in microfluidic structures. Microscale active valves, however, are relatively complicated and difficult to construct, even in 2- or 2½-D systems. Passive valves, which include structures such as capillary valves, capillary breaks, and the like, have the advantage that they do not require electrical interfacing or mechanical parts, and therefore are simpler to incorporate in devices. Hydrophilic capillary valves are commonly used in microfluidic devices, but tend to be unstable. A hydrophilic capillary valve in a hydrophilic material creates only a local minimum in hydrostatic pressure, and can be easily breached by fluid flow momentum or small disturbances, causing loss of flow control. In contrast, hydrophobic passive valves, as disclosed in U.S. Pat. No. 6,296,020, incorporated herein by reference, create global minima in hydrostatic pressure, and therefore give more stable flow control.

Control elements used in microfluidic systems, including electrodes for electro-kinetic or electro-hydrodynamic fluid control, mechanical valves or pumps, and heating elements, all require electrical interfacing. If these control elements are to be externally controlled, electrical traces must be brought to the exterior of the device. Accordingly, methods of constructing multi-layered microfluidic devices should, ideally, allow for electrical traces to be brought to the outside of the device, and for layers of the device to be sealed together, while maintaining the integrity of the electrodes.

Although many features important to the implementation of fully functional three-dimensional or multi-layered microfluidic devices have been identified, and devices incorporating various of these features have been constructed, there remains a need for a three-dimension or multi-layered microfluidic device which truly integrates these various design considerations. The ideal multi-layered device should be designed in such a way that layers of the device can be aligned easily and accurately during construction of the device. The device should be constructed in such a manner that reliable, leak-free sealing between layers is obtained. In certain applications it may be desirable for the device to have the capability of being disassembled after use for cleaning and/or reuse of all or portions of the device, for disposal of portions of device containing waste, or for retrieval of sample/reagent contained within device. Effective control of fluid movement within the microfluidic device is, of course, critical. Finally, in order for the device to be manufactured commercially, it is desirable, if not essential, for the three-dimensional microfluidic device to be manufactured by a simple and reliable process from inexpensive and readily available materials.

### SUMMARY OF THE INVENTION

The present invention is a multi-layered microfluidic structure incorporating a three-dimensional microfluidic circuit. The construction of the device is described, and specific embodiments of the device incorporating particular three-dimensional microfluidic circuits are presented. The device is formed from multiple layers of plastic materials having microfluidic circuit elements formed in one or more surfaces or passing through the layers. Hydrophobic base and/or coating materials are used extensively in the invention, because they confer upon the device desirable between-layer sealing and improved passive valve performance for control of fluid movement. In a preferred embodiment, the invention incorporates microfluidic circuits based upon passive fluid control structures. Selected layers of the device are releasably sealed to each other to permit disassembly of the device for cleaning, for separation of reusable and disposable portions of the device, and for reversible mating of the device to substrates such as microarray slides or microtiter plates.

It is an object of the invention to provide a multi-layered, three-dimensional microfluidic device that can be manufactured simply and easily from inexpensive and readily available materials.

It is a further object of the invention to provide a three-dimensional microfluidic device with the capability of simple, effective and versatile control of fluid movement within the device. This is accomplished by the use of pressure-driven flow in combination with valves to direct fluid flow. Valves utilized in the invention do not require complex mechanical structures to be constructed in the device.

Another object of the invention is to provide a method of sealing layers of a multi-layered microfluidic device in a reliable, leak-free manner.

Yet another object of the invention is to provide a leak-free method of sealing layers of a multi-layered microfluidic device that is also releasable. This makes it possible to disassemble the device after use to permit the reuse of portions of the device, disposal of other portions of the device, and retrieval of materials contained within device.

Another object of the invention is to provide a multi-layered microfluidic device that includes active components such as electrodes, heating elements, or sensors.

Another object of the invention is to provide a multi-layered microfluidic device that incorporates mixing technology.

Still another object of the invention is to provide a multi-layered microfluidic device capable of mating to conventional substrates such as slides or microtiter plates. This provides the advantage of integrating microfluidic pre- and post-processing capabilities with reactions carried out on or in conventional substrates with microvolumes of fluid.

### BRIEF DESCRIPTION OF THE DRAWINGS

In order that the manner in which the above-recited and other advantages and objects of the invention are obtained will be readily understood, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an exploded view of a multi-layer device incorporating layers including active elements and microfluidic circuitry;

FIG. 2 is an assembled view of the device of FIG. 1;

FIG. 3A depicts a multi-layer device for performing serial dilutions and ELISA;

FIG. 3B is a schematic of the basic microfluidic circuitry of the device of FIG. 3A;

FIG. 4 is a multi-layer device for processing a sample and delivering it to a microarray slide with three different hybridization solutions;

FIG. 5 is a top view of overlapping channels in a multi-layer microfluidic structure;

FIG. 6 is a cross-sectional view of the structure of FIG. 5, taken along section line 6-6;

FIG. 7 is a top view of overlapping channels in an alternative multi-layer microfluidic structure;

FIG. 8 is a cross-sectional view of the structure of FIG. 7, taken along section line 8-8;

FIG. 9 is a top view of overlapping fluid channels formed in a thin-sheet multi-layer structure;

FIG. 10 is a cross-sectional view of the structure of FIG. 9 taken at section line 10-10;

FIG. 11 is a cross-sectional view of the structure of FIG. 9 taken at section line 11-11;

FIG. 12A is an exploded view of a multi-layer structure containing a well;

FIG. 12 B is an assembled view of the structure of FIG. 12A;

FIG. 13 is a perspective view of a fluid channel with a passive valve, formed in the surface of a substrate;

FIG. 14 is an exploded view of a passive valve formed in a multi-layer structure;

FIG. 15 is a cross-sectional view of the assembled passive valve of FIG. 14;

FIG. 16 is an exploded view of a multi-layer structure incorporating an alternative passive valve;

FIG. 17 is a cross-sectional view of the assembled passive valve of FIG. 16;

FIG. 18 is a perspective view of fluid channels formed in opposite faces of a substrate and connected by a narrow via passing through the substrate;

FIG. 19 is a cross-section of the structure of FIG. 18 taken at section line 19-19;

FIG. 20 is a cross-section of the structure of FIG. 18 taken at section line 20-20;

FIG. 21 illustrates a branching structure formed in the surface of a substrate and used for dividing a fluid stream;

FIG. 22 is an exploded view of a multi-layer structure including a branching structure analogous to the branching structure of FIG. 21;

FIG. 23 illustrates an alternative branching structure for dividing a fluid stream, formed in the surface of a substrate;

FIG. 24 is an exploded view of a multi-layer structure for dividing a fluid stream including a branching structure analogous to the branching structure of FIG. 23;

FIGS. 25A-25D illustrate steps of mixing two fluids flowing in series in a microfluidic mixing element; and

FIG. 26 is an exploded view of a multi-layer structure in a mixing element analogous to that shown in FIGS. 25A-25D is implemented.

### DETAILED DESCRIPTION OF THE PREFERRED EMBODIMENTS

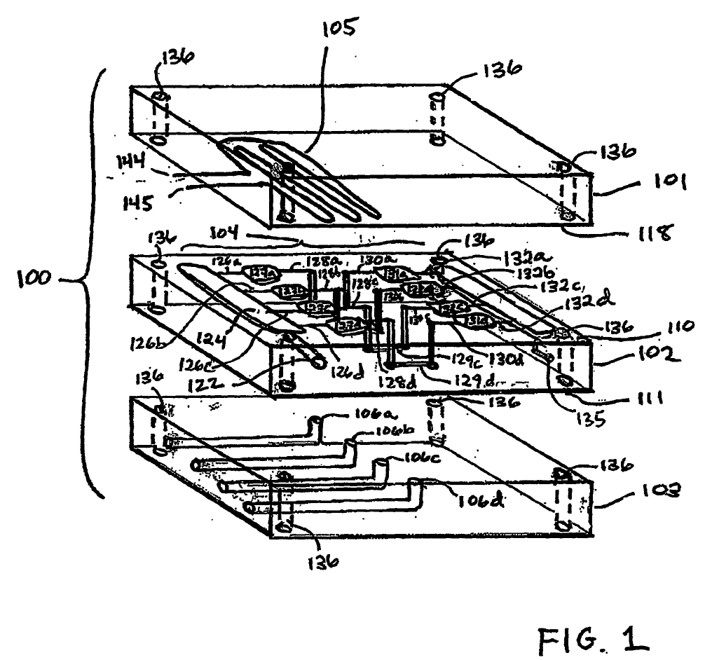

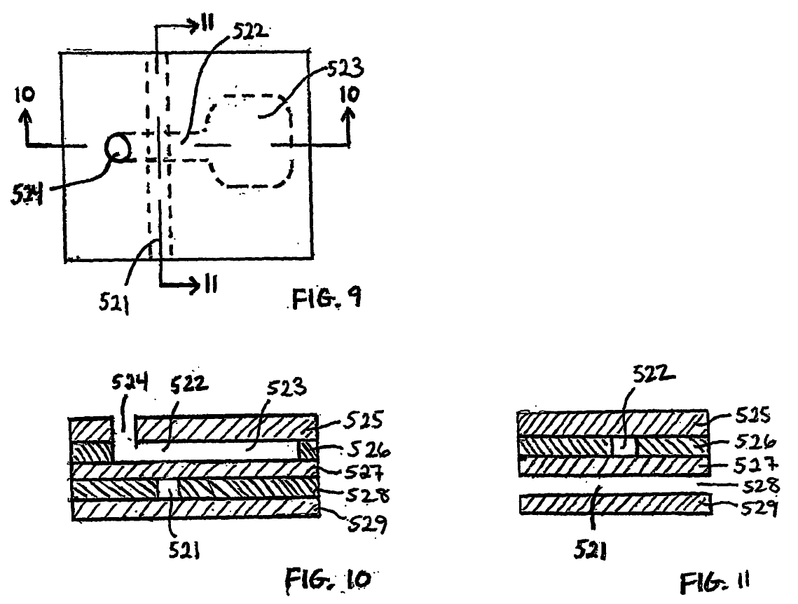

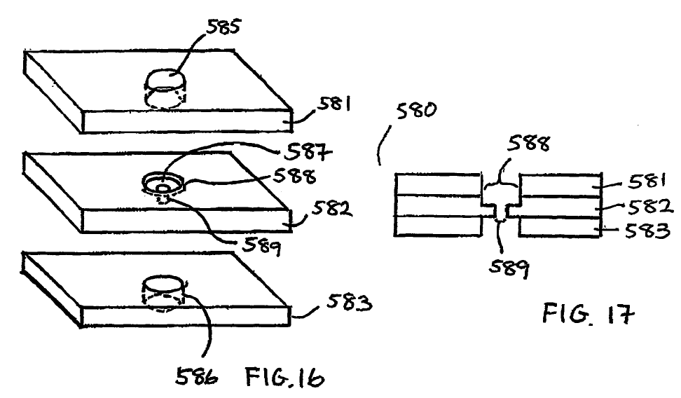

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 26, is not intended to limit the scope of the invention, as claimed, but is merely representative of presently preferred embodiments of the invention.

The basic three-dimensional structure of the present invention is constructed from multiple thin layers of plastic substrate material sealed together in a leak-free and (optionally) reversible manner. Layers may be rigid or flexible, but in general are flat and substantially planar when assembled together. Microfluidic structures are formed in the surfaces of individual layers, or through the entire thickness of individual layers, by easily-implemented methods such as molding, micromachining, laser abation, or die cutting. Microfluidic structures thus are primarily formed in planes corresponding to the planes of the substrate layers, although certain structures pass through layers. The exact nature of the layers and the method of sealing vary depending on the particular embodiment of the invention.

In a first embodiment of the invention shown in exploded view in FIG. 1, multi-layer microfluidic device 100 includes layers 101, 102 and 103, which are formed of relatively thick, rigid material. In this exemplary embodiment of the invention, a single layer 102 containing microfluidic circuit 104 is assembled together with layer 101, which contains 20 heating element 105, and layer 103, which contains active valves 106a-106d. Microfluidic circuit 104 comprises microfluidic channels and wells formed in both upper surface 110 and lower surface 111 of layer 102, connected by vias 115a-115d and 116a-116d. The depths of the channels and wells of microfluidic circuitry 104 are less than the thickness of layer 102. The lower surface 118 of layer 101 seals against upper surface 110 of layer 102 to form the upper surface of the microfluidic channels 124, 126a-126d, 128a-128d, 130a-130d, 132a-132d, and 133 and wells 127a-127d and 131a-131d formed therein. The upper surface of layer 103 seals against lower surface 111 of layer 102 to form the lower surface of channels 129a-129d formed therein, and to cause active valves 106a-106d to engage channels 129a-129d. In FIG. 1, valves 106a-106d are pneumatically activated valves which, when activated, project into channels 129a-129d to obstruct the flow of fluid in the channels. Alternatively, valves 106a-106d could be various other types of active valves, including but not limited to mechanical valves, remote valves, and hydraulic valves.

The microfluidic circuitry shown in FIG. 1 is designed for performing polymerase chain reaction (PCR) with a DNA sample to detect sequences of interest, but could be used to implement various biochemical reactions, and particularly those which require that sample be subject to one or more heating steps. Such reactions include, but are not limited, to various reactions used in DNA processing, for example, PCR, which requires multiple heating steps (thermal cycling), or ligase chain reaction (LCR) or rolling circle amplification (RCA) for DNA amplification, or cycle sequencing, all of which use a single isothermal heating step. A PCR cocktail containing DNA sample of interest, but without primers, is pumped (with the use of a syringe pump, for example) into inlet 122 of layer 102. From inlet 122 it moves into distribution channel 124, and then into channels 126a-126d leading to wells 127a-127d. Wells 127a-127d contain primer pairs for different amplicons. In general, wells 127a-127d can be considered to be thermal reaction wells, since they are adapted to contain reactants during one or multiple heating steps, as discussed above. While fluid is injected into device 100, valves 106a-106d are in the open position, to allow air within the circuit to move through the circuit ahead of the sample, and escape through air vent 135. Once wells 127a-127d have been loaded with sample, valves 106a-106d are closed, and heating element 105 cyclically heats wells 127a-127d to perform a PCR reaction. Because valves 106a-106d are closed, the increase in pressure during heating cannot drive fluid from wells 127a-127d into wells 131a-131d. Once the PCR reaction has been completed, the reacted sample is driven into wells 131a-131d, which contains a dye or other compound used in the detection of the reaction product formed in the thermal reaction wells. For example, pico green dye can be used for to label amplified DNA sequences produced by PCR to produce a fluorescent signal that can be detected to determine the presence or quantity or reaction product. The device is disassembled to permit dye in wells 131a- 131d to be read to quantify the amount of reaction products, or, if the device is formed at least in part of transparent material (i.e., transparent to the detected wavelengths), it may be possible to detect reaction products without disassembling the device.

The material from which layers 101, 102 and 103 are formed may be hydrophobic, or hydrophilic, with surfaces of the layers and the structures formed therein treated so that they are hydrophobic. Suitable hydrophobic materials include PTFE, FEP or PFA. Examples of non-hydrophobic materials are silicon, glass, PET, PMMA, or PC. These materials can be coated with hydrophobic materials such as Teflon or Teflon AF, by techniques such as vacuum deposition, spin coating, or vapor deposition. Different layers may be of different thicknesses. Without limitation, layers may range in thickness from about a millimeter to several centimeters.

Layers 101, 102 and 103 of device 100 are held together by clamping, as shown in FIG. 2. The clamp depicted in FIG. 2 includes top frame 140 and bottom frame 141. Layers 101, 102 and 103 are held in alignment by alignment rods 142 that pass through alignment holes 136 in each layer. At least two alignment holes and alignment rods must be used in order to align the layers of the device. Alignment holes 136 are also visible in FIG. 1. Alignment rods 142 are preferably spring-loaded to apply compressive force to hold the layers of device 100 together, and threaded to permit them to be screwed into bottom frame 141. Various other methods of assembling the layers with alignment rods may also be devised by one of ordinary skill in the art, and the invention is not limited to any specific method. For example, alignment rods may function only to provide alignment, and the compressive force needed to seal the layers together could be applied by a separate clamp mechanism. Additional features visible in FIG. 2 are electrical traces 144 and 145 connecting to heating coil 105, pneumatic drive lines connected to pneumatically activated valves 106a-106d, fluid inlet 122, and air vent 135.

If the external surface of each substrate layer is hydrophobic, or hydrophobically coated, the sealing together of the various layers is less critical than if they are hydrophilic, because hydrophilic capillary forces that draw fluid into cracks between layers will be absent. Thus, it is possible to simply hold together the substrate layers without additional the use of gaskets or adhesives. The layers must be held together firmly enough that fluid flow under normal pressures will not push them apart. It is also important that they are smooth, flat, and held together closely and uniformly enough that no large gaps are generated. This will be sufficient to provide a leak-free connection between layers because the amount of pressure required to cause fluid flow into small gaps (on the order of a couple micrometers or less) is substantial. A desirable feature of this type of device is that it can be assembled at biochemically compatible temperatures, thereby making it possible to incorporated biochemical reagents into the device at the time of assembly.

FIG. 3A shows an alternative embodiment of the first “thick layer” version of the invention, in which layer 301 of compliant material is included as a gasket to enhance sealing between layer 302 of the device and substrate 303, to which it is interfaced. As with the device of FIGS. 1 and 2, a clamp (not shown) would hold the layers together in sealing relationship. Compliant layer 301 may deform plastically or elastically, or a combination thereof. Compliant material may be sheet material that is cut and assembled into the device as a separate layer, as shown here, or a compliant layer may be applied to layer 302 by a printing technique such as screen printing or stenciling. Compliant materials include various natural or synthetic polymeric materials, rubbers, and waxes, for example. Gasket layers may have the same pattern of openings as one of the adjacent layers, and simply perform a sealing function, with the depth of the microfluidic structures primarily defined by the adjacent rigid layer, or, as shown here, the gasket may have a pattern of openings that defines microfluidic structures independent of those defined by openings in the adjacent rigid layer, with the depth of the microfluidic structures in the gasket layer defined by the thickness of the gasket layer. Gasket layers may be only a few microns thick, or may be considerably thicker, particularly if the gasket layers define microfluidic structures, rather than simply performing a sealing function. It is contemplated that gasket layers would typically range from about 0.1 micron to about 500 microns in thickness, but they could be as thick as several millimeters. In the example of FIG. 3A, openings 310a-310e define wells bounded above by lower surface 312 of layer 301 and bounded below by upper surface 314 of substrate 303. Regions 3181-318e of substrate 303 contain immobilized capture antibodies that are thus contained in wells 310a-310e. Microfluidic circuitry of this device is designed to perform serial dilution and ELISA (enzyme linked immuno-absorbent assay) and will be described in greater detail below.

In another variant of the above device (not shown), at least some layers of the device are bonded together with an adhesive, with thermal bonding, or with another bonding technique. The appropriate choice of adhesive is dependent on the particular materials to be bonded.

In another variant of the above device, at least some of the layers are formed of non-hydrophobic material, with only selected regions of the device formed of hydrophobic material or having a hydrophobic coating. Non-hydrophobic layers are sealed to other layers by bonding, adhesive, or clamped with a gasket between to provide a leak-free seal.

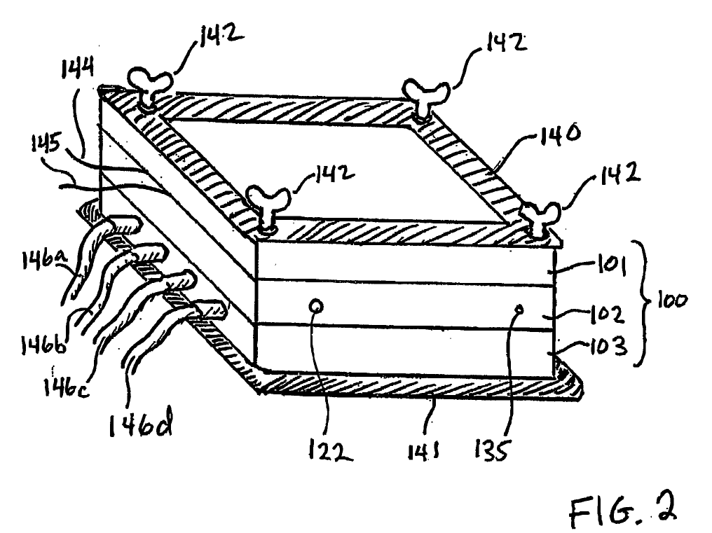

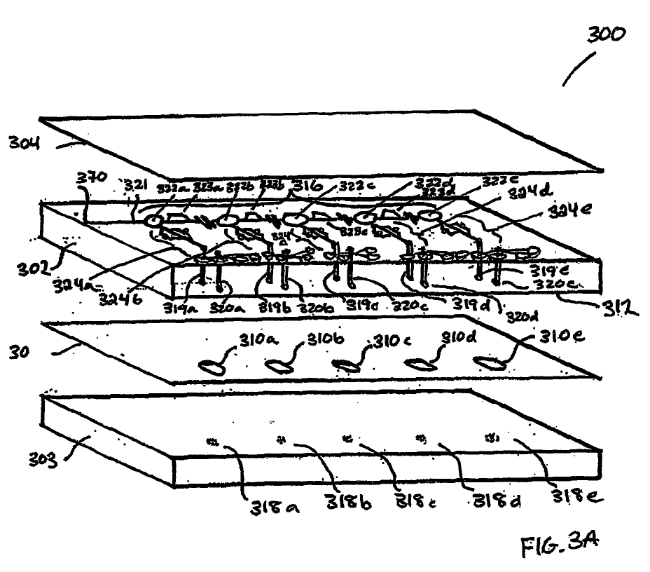

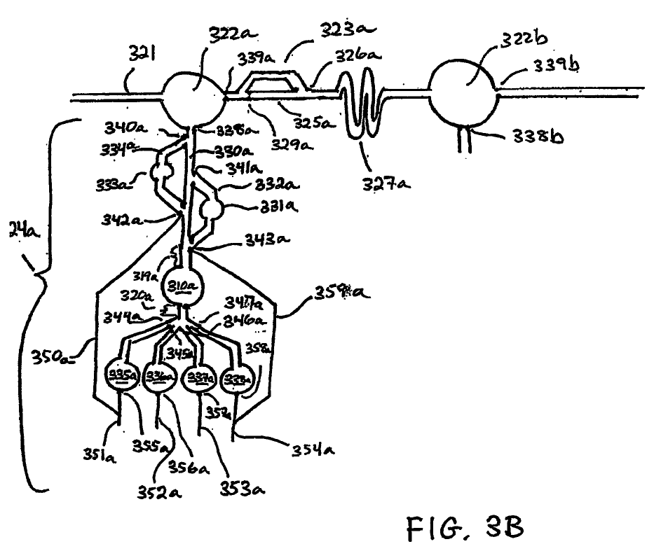

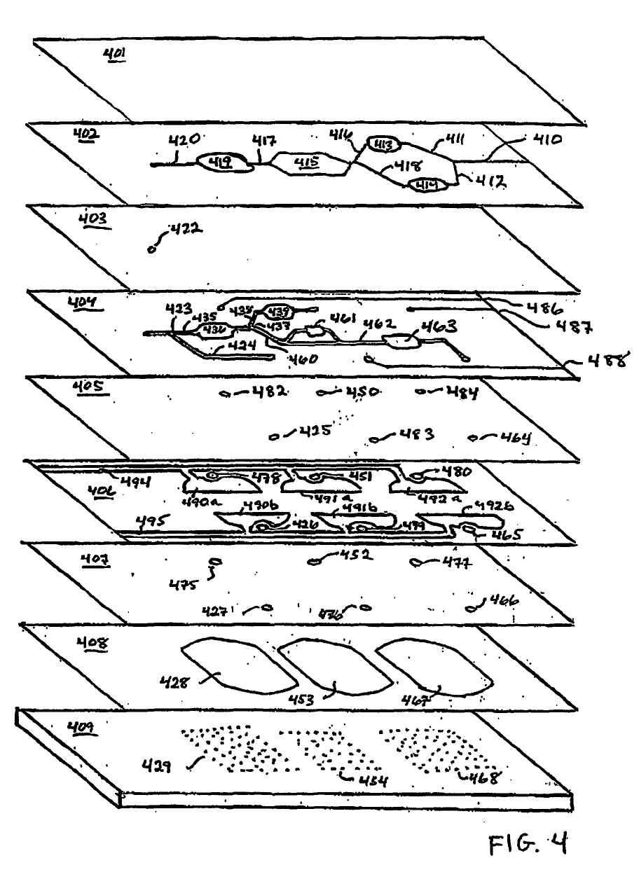

In a second version of the device, as illustrated in FIG. 4, multiple layers 401-408 are formed of thin, relatively flexible sheet material. Suitable materials include various polymeric materials such as acrylics and polyesters, and Mylar™. Microfluidic structures are formed through entire layer thicknesses, and may have the thickness of one or more layers. Sheet materials may range in thickness from about 10 microns to about 1 millimeter, with typical thicknesses for sheet materials are from about 5 to about 500 microns. Layer thicknesses of about 10 to about 100 microns are preferred for many microfluidic applications. Different layers may be formed of different materials and may have different thicknesses. Layer materials may be hydrophilic or hydrophobic, and may be treated in regions or over the entire surface to modify the surface hydrophobicity/hydrophilicity. An adhesive layer 408 may be used to seal the device to a substrate 409 to which it is interfaced, and/or to additional portions of the device formed from more rigid materials. One example of a suitable adhesive is an acrylic polymer (such as 3M 501FL).

The choice of method for constructing the inventive device depends whether the device is to be a prototype or custom device, or part of a large-scale production run, and whether structures are formed in the surface of thicker layers, or through the entire thickness of (typically) thinner layers. For prototyping and custom devices, a preferred method of construction is a laser ablation technique as described in PCT publication WO 0074890, incorporated herein by reference. If thin layers are used, structures are cut through the entire thickness of layers; this can be done easily with a CO₂ laser or other infra-red laser. If smaller features, or structures that have depths less than the thickness of the substrate layer, an excimer laser is preferably employed to provide greater depth control. Fluid circuits can be fabricated by excimer laser ablation in standard fluorocarbon materials if they are doped with a carbon black additive to increase the material's UV absorption.

For prototype and custom devices, microfluidic structures in layers can also be formed by micromachining. For large-scale production of devices, it is preferred that layers of microfluidic structures are formed by injection molding. Gasket materials may be obtained in sheet form and die or laser cut, or may be applied by silk screening or other printing techniques.

In embodiments of the invention formed from thin layers, for prototype purposes, microfluidic structures can be formed in individual layers by laser cutting or even hand cutting with a scalpel or Exacto™ knife (although this method is obviously not particularly reproducible). For large-scale production, die cutting is preferred; laser cutting is also a suitable method. Single- or double-sided adhesive sheet materials, consisting of plastic sheet materials with adhesive on one or both faces, may be used for some or all layers or the device. Such materials may also be die-cut or laser cut.

As noted previously, while it is desirable to attach layers of multi-layer devices together in a leak-free manner, for certain applications it is also desirable that at least certain layers can be subsequently released and separated from each other. This is the case for example, if the device includes a single-use, disposable portion (fluid processing circuitry containing samples and reagent, for example), and a reusable portion (containing electronics, heaters, etc.), which after each use is separated from the disposable portion and saved for reuse with additional disposable portions. For example, the device of FIGS. 1 and 2 includes two reusable substrate layers 101 and 103, which contain active components.

In some embodiments of the invention, as shown in FIGS. 3A and 4, a microfluidic device formed of multiple layers is interfaced with a substrate such as a glass microscope slide, so that portions of the substrate, and biochemicals immobilized thereon, are essentially incorporated into the microfluidic circuitry of the device, so that microfluidic processing can be carried out on materials on the substrate. Following processing of the materials on the substrate, it may be desirable to separate the microfluidic device from the substrate so the substrate may be subject to additional processing or evaluation steps that are not possible when the microfluidic device is in place.

As noted previously, a leak-free seal may be formed between two hydrophobic faces just with clamping. If a device is simply clamped together, it is a simple matter to disassemble the device when desired. To seal layers formed of weakly- or non-hydrophobic materials, or combinations of hydrophobic and hydrophilic materials, a gasket that is capable of elastic or plastic deformation can be placed between layers to provide sealing that can be released as needed. Furthermore, certain appropriately selected adhesives can be used to provide releasable sealing. If two surfaces formed of or coated with different materials are to be sealed together with an adhesive, the adhesive should be selected to adhere preferentially to one of the surfaces, so that when the layers are separated, the adhesive will stick to one of the surfaces, but release from the other. In this manner, the adhesive layer remains intact on one of the surfaces and is fully removed from the other. It is particularly desirable for adhesive to be fully removed from the reusable portions of a device, or from substrates that are subject to additional processing or evaluation.

A variety of microfluidic circuit elements can be formed in multi-layer microfluidic devices constructed according to the present invention. The most basic structures are channels and wells Or chambers, and these can be formed by a number of approaches. As will be discussed herein below, these structures can be formed in a surface, or through the thickness of a single layer of a multi-layered structure, and thus lie substantially in a single plane parallel to the layer. They can also be formed so that they pass through multiple layers of a multi-layer structure. A typical multi-layer structure will include structures formed in a number of different planes corresponding to different layers, connected by via channels or other structures that pass through multiple layers, with at least some of these latter structures providing fluid communication between fluid circuits in different planes.

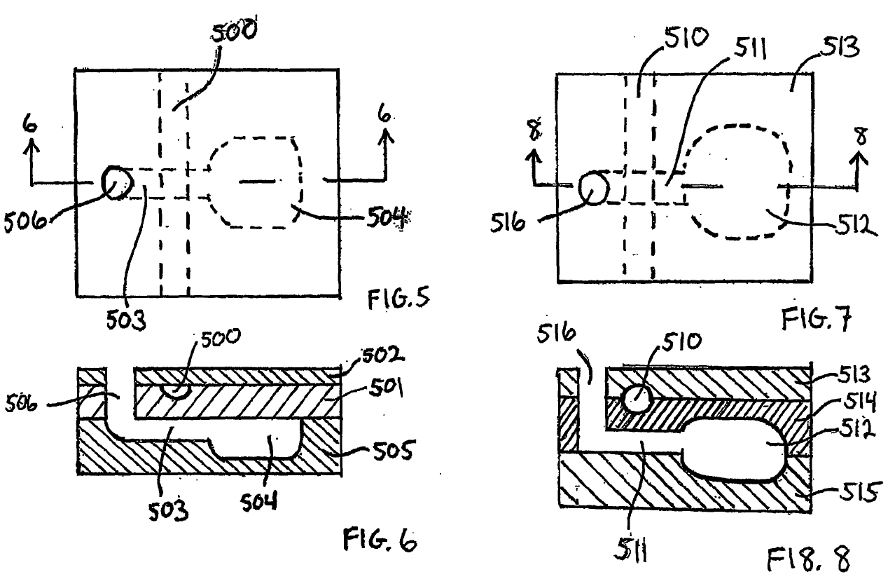

FIGS. 5-11 illustrate several methods of forming channels in multi-layer microfluidic structures. Channel 500 is formed in the top surface of layer 501, with the sides and bottom formed by layer 501 and the top surface formed by layer 502. Similarly, channel 503 and well 504 are formed in the top surface of layer 505, and closed at the top by the lower surface of layer 501. Via hole 506 is cut through layers 502 and 501 and partly into layer 505. It is also possible to form the top and bottom portions of channels and wells in two different layers, as depicted in FIG. 8, e.g., channel 510 is formed in layers 513 and 514, while channel 511 and well 512 are formed in layers 514 and 515. In this example, layer 514 has structures formed on both faces, as well as a via channel 516 passing through its thickness. When a channel does not pass through the entire thickness of a layer, a second, overlapping channel can be formed in an adjacent layer, as shown in FIGS. 5 and 6, or in the underside of the same layer if it is thick enough, as shown in FIGS. 7 and 8. These structures can be formed by laser ablation, machining, or injection molding, or various other microfabrication techniques. The same techniques can be used to form vias (defined as channels running from one level to another, typically perpendicular to the layers). However, if layers of a multi-layer structure are thin, so that channels and other structures are formed through entire thickness of a sheet, overlapping channels cannot be formed in adjacent sheets, but must be separated by at least one intermediate layer, as shown in FIGS. 9-11. The shapes of channel 522 and well 523 are defined by layer 526, while the upper and lower surfaces of these structures are defined by layers 525 and 527, respectively. Similarly, channel 521 is defined by layers 527, 528, and 529. This method of channel formation is particularly suited for multi-layer devices formed from thinsheet materials, but can also be used with thicker layers. Channels and vias can be formed by laser cutting or die cutting in this method.

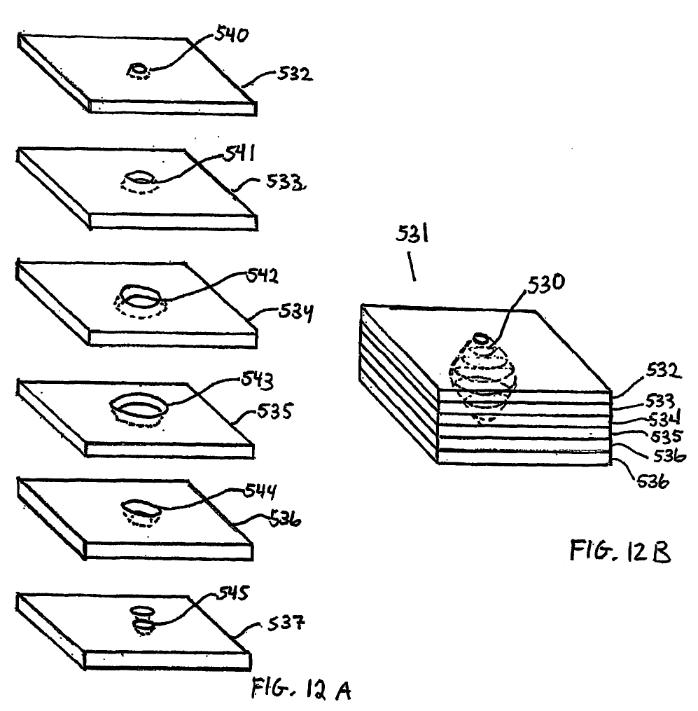

Chambers or wells are also important components of microfluidic systems. Fluids are typically delivered to chambers or wells for performance of various types of reactions or analyses. The size, shape and orientation of a chamber or well depend on the specific application for which it is designed, the volume of fluid to be contained by the well, the desired flow characteristics of the well, and the orientation of the well relative to other fluid circuit components. A simple method of forming a well is to form the bottom and sides of the well in a single layer, with the upper surface formed by an adjacent layer. The upper surface can simply be planar, as illustrated in FIG. 6, or shaped to further define the size and shape of the well, as illustrated in FIG. 8. The approach shown in FIGS. 5-8 is particularly suited for devices formed from relatively thick, rigid layers. For devices formed from multiple thin layers, the approach shown in FIGS. 9-11 can be used. In this example, the shape of the well is defined by one layer, and the top and bottom surfaces of the well are planar and defined by adjacent layers. However, a well thus formed will not have much depth, and thus may have a lower than desired volume, or larger than desired surface-volume ratio. In order to form a well with greater depth, a well (e.g. well 530 in FIGS. 12A and 12B) can be formed through multiple layers 532-537 of a multi-layer structure 531. If layers 532-537 are thick compared to the dimensions of well 530, the walls of well cavities 540-545 in layers 532-537, respectively, may be sloped to provide well 530 with a smooth interior surface. Sloped walls can be generated with both molding and laser cutting manufacturing techniques.

Valves comprise a third basic component of microfluidic circuits, along with channels and wells. Although various types of valves may be used in the practice of the invention, in the preferred embodiment passive valves, and in particular hydrophobic passive valves, are used. The construction of hydrophobic passive valves is described in detail in U.S. Pat. No. 6,296,020, incorporated herein by reference. Such valves are readily formed in single layers of microfluidic devices, in the form of a long or short abrupt channel narrowing or widening. Passive fluid control which utilizes hydrophobic materials and hydrophobic capillary valves is preferred for its stability. Aqueous fluids are not drawn into hydrophobic channels, but need to be forced in under pressure. As the channel becomes narrower, more pressure is required to force the fluid to continue flowing. Resistance to established flow is approximately the same in a hydrophobic channel as in hydrophilic channel of the same diameter. However, the resistance to initial flow, or developing flow, when fluid enters the system for the first time and an air/fluid interface is present, is substantially higher. The difference between the resistances to developing and established flow in hydrophobic systems allows for much more reliable flow control, and makes it possible to generate much more complex fluid circuits than are possible in hydrophilic capillary systems, or in electrokinetic or electrohydrodynamic systems.

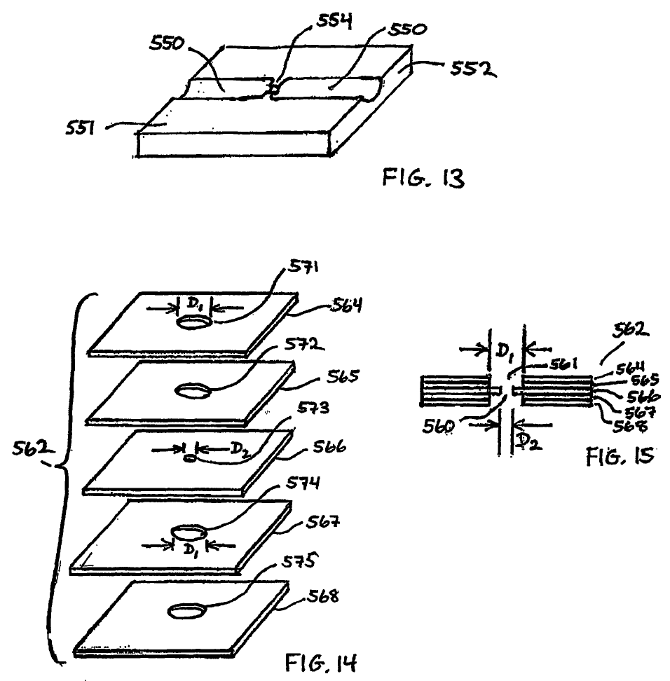

An example of a channel including a passive valve is shown in FIG. 13. Channel 550 is formed in surface 551 of substrate 552. Passive valve 554 is a short region of channel 550 having a reduced diameter. This type of passive valve can be implemented in individual layers of multi-layered systems, just as in 2 or 2½ D systems. It can also be implemented between layers, as shown in FIGS. 14 and 15. Multi-layer structure 562 is constructed from layers 564-568, where a channel 561 is formed by holes 571-575 in layer, 564-568, respectively. Each said hole has a diameter D₁ except for hole 573 in layer 566, which has a smaller diameter D₂, and thus forms a passive valve structure. This approach is particularly suited to devices formed from relatively thin layers.

In devices formed from thicker layers, channel narrowings can be implemented between two layers, as shown in FIGS. 16 and 17, or within a single layer, as shown in FIGS. 18-20, if the layer thickness and manufacturing technique permit structures to be formed in both faces of the layer.

Referring now to FIGS. 16 and 17, multi-layer structure 580 is formed from layers 581, 52 and 583. Layers 581 and 583 include openings 585 and 586, respectively, which have a uniform diameter throughout the layer thickness. Layer 582 includes opening 587, which has a section 588 having a large diameter corresponding to the diameter of openings 585 and 586, and a section 589 having a smaller diameter. Smaller diameter section 589 functions as a passive valve. FIGS. 18-20 depict a structure 590 formed of a thick central layer 598 having fluid channels 591 and 592 formed on opposing faces. Channels 591 and 592 are enclosed by layers 593 and 594, which are sealed to central layer 598. Narrow channel 595, which is essentially a via channel between channels 591 and 592, has a smaller diameter than either of these channels and functions as a passive valve. It should be note that a resistance to fluid flow is obtained not only as fluid enters narrow channel 595 from either channel 591 or 592, but also as fluid exits narrow channel 595 into widening 596, where the channel diameter increases abruptly. This type of abrupt channel widening may also be used as a passive valve for controlling the movement of fluid in microfluidic circuits, as disclosed in commonly owned co-pending patent application entitled, Fluid Circuit Components Based upon Passive Fluid Dynamics [Attorney Docket No. 3153.2.14], which is incorporated herein by reference.

Remote valving may be used as an alternative to or in addition to passive valves for controlling fluid flow in three dimensional microfluidic structures. Remote valving, which is described in U.S. patent application Ser. No. 09/922,451, incorporated herein by reference, utilizes mechanical valves located external to the fluidic system and connected to the fluid circuit by air ducts to control the movement of air out of the system. As fluid enters a fluid circuit for the first time, air that is within the system must be vented out as it is replaced by the fluid. If the air cannot escape, it will cause a backpressure that opposes further advancement of the fluid. Remote valving controls the venting of air from the fluid circuit, and thus controls the flow of fluid within the circuit. This simplifies microfluidic circuit fabrication, since any expensive and complex valving and control is done externally and can be made re-usable. Air ducts are constructed in the same manner as fluid channels, but typically have smaller diameters. Naturally, air can also escape through fluid channels that communicate with the atmosphere, providing they are not already filled with fluid.

Remote valving technology can be implemented in hydrophilic or hydrophobic systems. However, the use of hydrophobic air ducts is particularly advantageous since air escape is permitted, but fluid flow through air ducts is restricted. Air ducts formed in hydrophilic materials may be coated with hydrophobic material or covered with an air-permeable hydrophobic membrane to provide the benefits of hydrophobic air ducts.

In addition to controlling the venting of air from a microfluidic circuit to regulate fluid flow, positive or negative pressure can be applied to air ducts in selected regions of a microfluidic circuit to modulate fluid flow or reaction conditions, as described in PCT Publication No. WO 0188204, incorporated herein by reference.

Mechanical valves and other types of valves may be used in the practice of the invention. Mechanical valves may be electronically, pneumatically, or hydraulically actuated, for example. The invention is not limited to any particular type of valve.

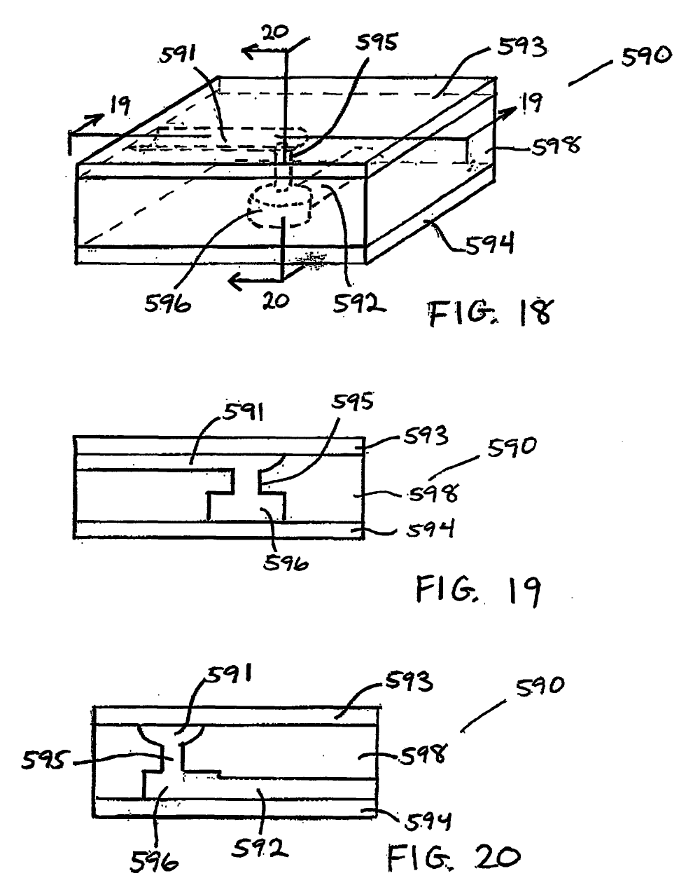

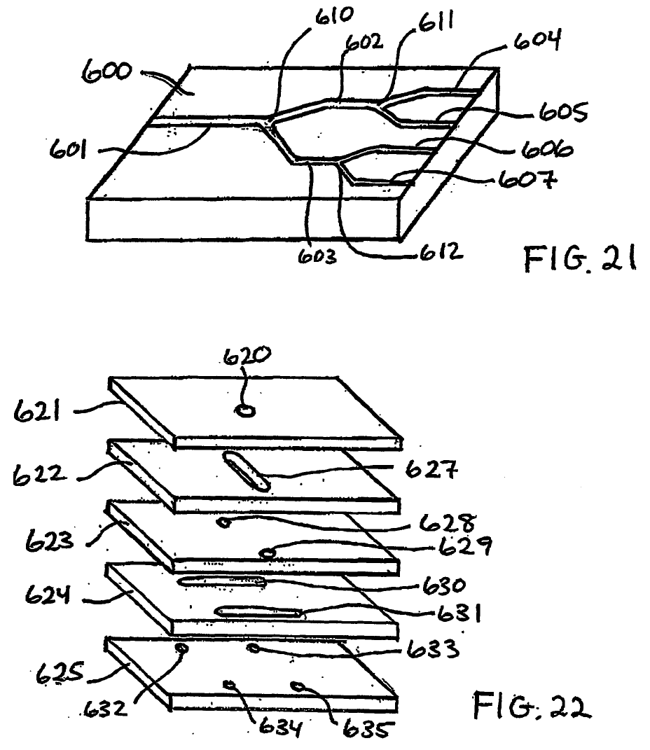

Microfluidic channels, chambers, and valves can be combined to perform various fluid processing tasks. One basic task is to divide a fluid stream among multiple channels. This task is facilitated by the use of passive valves. As disclosed in U.S. Pat. No. 6,296,020, incorporated herein by reference, the flow of fluid in a network of branching channels can be controlled by providing a set of passive valves at each generation of branches, through which the fluid must pass to reach subsequent generations. By making each generation of barriers “stronger” than the previous set, fluid is made to fill all branches of the current generation before moving into the next generation of channels. This can be accomplished, for example, by making each successive capillary barrier narrower than the previous set. A branching circuit formed in a single substrate layer 600 is depicted in FIG. 21. Fluid flowing in a single channel 601 is divided into two channels 602 and 603, and subsequently into four channels 604, 605, 606, and 607. Capillary barriers are located at 610, 611, and 612. The branching circuit of FIG. 21 can be implemented within a single layer of a multi-layer system, or, as shown in FIG. 22, a comparable circuit can be constructed between layers. Fluid enters the structure of FIG. 22 through inlet channel 620 in layer 621. From there, it enters the central region of primary branch channel 627 in layer 622, and flows to either end. Primary via channels 628 and 629 in layer 623 are smaller in cross-sectional area than primary branch channel 627, and thus primary branch channel 627 fills completely before fluid flows through primary via channels 628 and 629. Primary via channels 628 and 629 thus act as passive valves. Similarly, secondary via channels 632-635 in layer 625 have smaller cross-sectional areas than channels or holes in preceding layers, thus providing higher resistance to fluid flow and forcing fluid to fill secondary branch channels 630 and 631 completely before moving through secondary via channels 632-635.

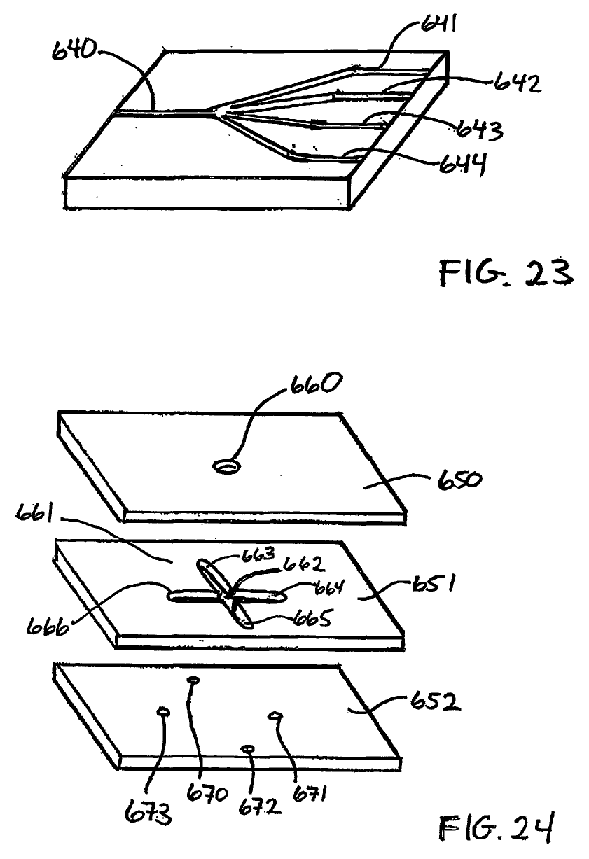

FIGS. 21 and 22 illustrate a branching circuit having a binary branching pattern. As shown in FIGS. 23 and 24, other branching patterns may be used as well. In the single-layer version of FIG. 23, a single inlet channel 640 branches into four channels 641, 642, 643, and 644 in one step. In FIG. 24, fluid enters at hole 660 in layer 630, and enters branched channel 661 in layer 651 at central region 662. It then flows to the ends of arms 663, 664, 665, and 666 of branched channel 661. Outlet channels 670, 671, 672 and 673 in layer 652 provide greater resistance to fluid flow than the arms of branched channel 661, so all arms of channel opening 661 fill before fluid moves into any of outlet channels 670-673, thus ensuring uniform distribution of fluid between the channels.

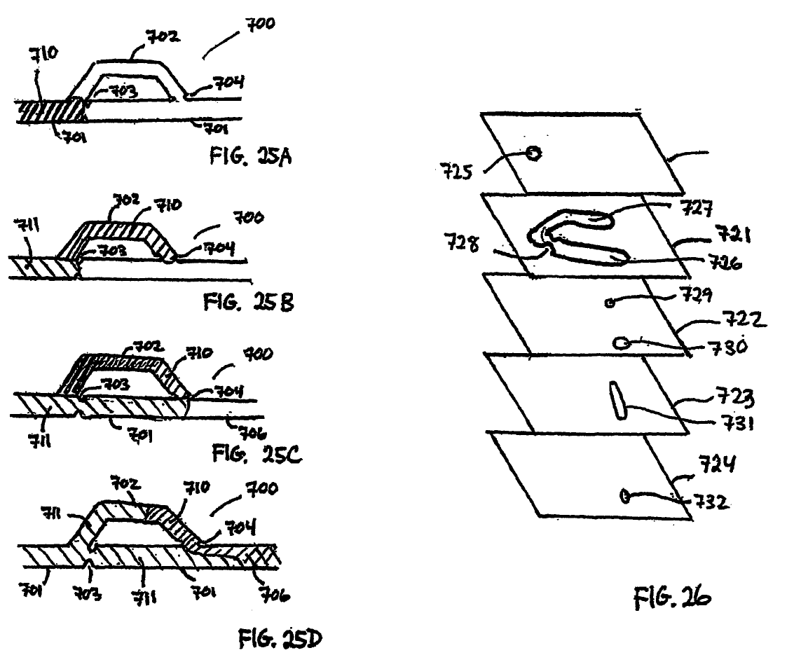

Another basic microfluidic circuit component made up of a combination of channels and passive valves is mixer 700, as depicted in FIG. 25A-25D. The function of the mixer 700 is to mix first fluid 710 and second fluid 711 that are flowing one after another in a main channel 701, by diverting first fluid 710 into side channel 702, and then injecting first fluid 710 back into downstream portion 706 of the main channel to flow side-by-side with second fluid 711 to permit diffusional mixing. The operation of the mixing circuit is as follows. As shown in FIG. 25A, first fluid 710 moves into main channel 701 under pressure from a pressure source such as a programmable syringe pump. First fluid 710 encounters passive valve 703, which stops its flow in main channel 701. As shown in FIG. 25B, first fluid 710 is diverted into side channel 702 by passive valve 703, because it encounters less resistance to flow than in main channel 701. First fluid 710 flows into side channel 702 until it encounters passive valve 704. Note that the volume of first fluid 710 is selected to just fill side channel 702, and that first fluid 710 is followed by second fluid 711, which pushes first fluid 710 ahead of it as it moves into main channel 701. Passive valve 704 is selected to provide a greater resistance to flow than passive valve 703, and therefore, as additional second fluid 711 is driven into main channel 711, it breaks through passive valve 703 first, and flows further into main channel 701, as depicted in FIG. 25C. When second fluid 711 reaches the intersection of side channel 702 with main channel 701, second fluid 711 wets the downstream side of passive valve 704, which disrupts the air-liquid interface that prevented fluid flow. As shown in FIG. 25D, as additional second fluid 711 is pushed in main channel 701, the first fluid 710 from side channel 702 and second fluid 711 from main channel 701 flow together into the downstream segment 706 of the channel 701.

The mixer circuit depicted in FIGS. 25A-25D can also be implemented in multiple thin layers. If multiple thin layers are used such that fluid circuit structures are cut through entire layer thicknesses, the “island” of material surrounded by the main channel and the side channel will be unsupported, which may complicate manufacturing. The circuit may thus be formed in multiple layers 720-724 as shown in FIG. 26. Fluid enters at opening 725 in layer 720. Main channel 726 and side channel 727 are formed in layer 721, as is passive valve 728. Small opening 729 in layer 722 forms the passive valve just before the intersection of side channel 727 with main channel 726. The side and main channels come together at channel 731 in layer 723. Finally, fluid from main channel 726 and side channel 727 flow together out of opening 732 to downstream microfluidics (not shown). Alternatively, this circuit could be formed in a single thin layer if some position holder were provided to keep the “island” in position relative to the main portion of the substrate material. Such a position holder could be, for example, a pin inserted into the island from the top or bottom substrate, or a backing sheet that was removed once the “island” was secured to an adjacent layer during the manufacturing process.

It is frequently desirable for microfluidic devices to include active elements, such as electrodes, mechanical valves, heaters, pumps, sensors of various types, mixing elements, and other components. Mixing elements may include piezoelectric elements, air or fluid actuated bladders or membranes, and structures for circulating fluid or pumping it back and forth to perform a mixing function. Sensors include pressure transducers, optical transducers, flow measurement devices, and so forth. Because such components are typically more expensive to manufacture than basic microfluidic circuitry, it is preferred that such components are incorporated into a portion of the device that can be reused. According to the present invention, the microfluidic device may be formed of multiple pieces that can be sealed together during use, and then separated for cleaning (if necessary) and reuse. As illustrated in FIG. 1, active elements are contained in layers 101 and 103, which are sealed together with microfluidic layer 102.

The following examples illustrate how the microfluidic circuit structures and assembly methods described above can be implemented. These examples represent only a small sampling of the many possible structures that can be constructed according to the present invention, and the practice of the invention is not limited to these particular exemplary structures.

### EXAMPLE 1

FIGS. 1 and 2 depict a first example of a microfluidic device constructed from a number of relatively thick rigid layers, according to the invention, including reusable layers containing active elements, and potentially disposable layers containing passive microfluidic circuitry. The device depicted in FIGS. 1 and 2 is used for performing PCR-based screening of a DNA sample. A noted previously, it may also be used for LCR, RCA, or other reactions.

### EXAMPLE 2

FIG. 4 depicts a device that can be used for pre-processing sample and hybridization solutions for probe-oligo or probe-cDNA hybridizations on microarrays. Such a device could be used to identify suitable hybridization conditions prior to running a series of microarray hybridizations. Multiple hybridizations are performed on a single array under different conditions to minimize the slide-to-slide variation observed in microarray hybridization reactions, which obscures subtle differences in these gene expression experiments crucial in the drug discovery process. Sample can be dye-labeled and combined with hybridization solution in the device. Preparation of hybridization solutions having different concentrations of sample or other components can be carried out in the device. Salt buffer (SSC) and formamide are typical components of the hybridization solution that may be adjusted to maximize hybridization sensitivity. This is especially important when studying low abundance genes within the probe sample. The device performs the tasks of labeling probe solution and delivering labeled probe, in combination with hybridization solutions that vary in selected parameters, to several redundantly printed regions on the surface of a single microarray slide. By comparing hybridization results obtained with the different hybridization solutions on a single slide, the best conditions for hybridization can be identified.

Referring now to FIG. 4, a sample of purified probe DNA enters inlet 410 in layer 402, flows into channels 411 and 412, and is delivered to wells 413 and 414. Passive valves 440 and 441 at the outlets of wells 413 and 414 cause fluid to fill both wells before flowing further downstream. Each of wells 413 and 414 contains one of two different dyes. Probe DNA is incubated in wells 413 and 414, where it is labeled through covalent attachment of the dye. Labeled probe in each of these two microfluidic wells flows into channels 416 and 418, which merge and enter separation channels 415, which contain an in-channel chromatographic medium, such as an affinity or size exclusion matrix, to separate unlabeled probe and unreacted dye from the labeled probe. The purified, dye-labeled probes then leave separation channel 415 via channel 417, and are collected in chamber 419. They are delivered to layer 404 of the device through channel 420 and via hole 422 in layer 403.

In layer 404, purified labeled probe is divided into a number of portions, several of which are subject to further processing to modify parameters of interest. Purified, labeled probe is divided into two portions at split 423. Probe solution in channel 424 is moved through via channels 425 and 427 to opening 428 in layer 408, which forms an hybridization chamber containing region 429 of microarray slide 409. Probe solution in channel 435 enters well 436, which contains a first reagent that mixes with the probe solution. Reagent in well 436 modifies probe solution. Modified probe solution exits well 436 and is divided at branch point 437. A first portion of modified probe solution in channel 438 passes through well 439, where it is modified by the addition of a second reagent from well 439, and then delivered to region 454 of microarray 409, through via holes 450 and 459 to opening 453 in layer 408. Probe solution in channel 460 enters side channel 461 and is subsequently mixed with and diluted by additional probe solution. The diluted, modified probe solution moves through channel 462 to well 463, where a third reagent is added to it, and it is then delivered via openings 464, 465, 466 and the chamber formed in opening 467, to region 468 of microarray 409. As fluid enters chambers 428, 453, and 467, air escapes through via holes 475-477 in layer 407, 478-480 in layer 406, and 482-484 in layer 405, which connect to air vents 486-488 in layer 404, and from there to the atmosphere.

The reagents in wells 436, 439, and 463 may be any of a number of substances capable of modifying the hybridization reaction that will be carried out on the microarray surface. Reagents could include materials such as formamide, SSC, acids, bases, or buffers to modify the pH of the solution, salts to modify the ionic strength of the solution, detergents, etc. Reagents can be loaded into the device prior to use in dried (e.g., lyophilized) form, or, at least for relatively stable reagents, in liquid form. The functions embodied in the different layers of this device make it possible to eliminate a significant amount of the labor associated with the preparation of labeled probe solution and preparation of different hybridization solutions used in optimization experiments performed at the onset of all microarray-based studies.

A further feature of the invention, as illustrated in FIG. 4, is that it includes air bladders that are alternately inflated and deflated to produce agitation and mixing of fluid in the chambers 428, 452, and 467 formed on the microarray surface. Layer 406 includes air bladders 490a, 491a and 492a, which are connected to air line 494, and air bladders 490b, 491b, and 492b, which are connected to air line 495. Air line 494 and 495 are connected externally to a source of positive and negative pressure, which reciprocally inflates and deflates the air bladders to push fluid back and forth in chambers 428, 452, and 467. The use of air bladders for providing pneumatic mixing in hybridization chambers is described in detail in U.S. Provisional application No. 60/339,851, incorporated herein by reference. This mechanism for mixing can be incorporated into various embodiments of the invention, and is not limited to use in the particular embodiment depicted herein.

### EXAMPLE 3

FIG. 3A depicts a three-dimensional microfluidic device 300 that performs serial dilution of a sample and delivers sample solutions and a series of appropriate reagents/reactants to a diagnostic surface 303 for the performance of a multiplexed immunoassay, e.g., an Enzyme Linked Immuno-absorbent Assay or “ELISA”. The microfluidic circuit is designed to interface with a diagnostic surface 303 such as a slide or microtiter plate having small regions 3181-318e containing immobilized capture antibodies specific for a analyte(s) of interest The device has been simplified to more clearly illustrate its principles of operation. In practice, diagnostic surface 303 could contain a larger number of regions bearing capture antibodies, for example in an array made up of multiple rows, as opposed to a single row as depicted here. Device 300 would have a correspondingly larger number of microfluidic circuits to deliver sample and reagents to the larger number of regions bearing antibodies. The serial dilution steps performed by device 300 are necessary to insure that the immunological reaction used to measure the concentration of analyte in the sample is conducted within the linear range of the assay. Performing an immunological assay within its linear range is critically important for analytical accuracy.

The upper circuitry layer of device 300 is formed in the upper surface of substrate layer 302, and includes microfluidic circuitry 316 that performs serial dilutions of a sample containing an unknown concentration of one or more analytes of interest. Additional microfluidic circuitry on upper circuitry layer provides for the delivery of sample solutions and reagents in sequence to the diagnostic surface 303, so that immunological assays can be carried out. The circuitry 316 in substrate layer 302 is enclosed by a cover layer 304 sealed to the upper surface of substrate layer 302. Circuitry in the upper circuitry layer is connected to read wells formed on the diagnostic surface by down vias 319a-319e and up vias 320a-320e. Read wells are formed by openings 310a-310e in gasket layer 301 that correspond to regions 318a-318e containing immobilized capture antibodies on diagnostic surface 303.

Substrate layer 302 includes inlet 370 feeding into main channel 321, which leads to a series of samples wells 322a, 322b, 322c, 322d, and 322e, in which various dilutions of the sample solution are collected. In series along main channel 321 are microfluidic mixing modules 323a-323e of the type shown in FIGS. 25A-25D, which perform the serial dilution steps by mixing sample solution and buffer. Branching off the main channel at each sample well are multiple identical ELISA circuits 324a-324e, in which ELISA reactions are performed on the different serial dilutions of the sample. First ELISA circuit 324a is detailed in FIG. 3B; the operation of the other ELISA circuits is equivalent. As shown in FIG. 3B, first ELISA circuit 324a includes main channel 330a; conjugate well 333a located on side channel 334a and containing lyophilized enzyme-antibody conjugate formed with an antibody specific to the analyte(s) of interest; substrate well 331a located on side channel 332a and containing lyophilized substrate, with which the conjugate will generate a detectable reaction product; read well 310a on diagnostic surface 303; and waste wells 335a, 336a, 337a, and 338a. All wells and channels are located on layer 302 of the microfluidic device except for read well 310a, which is located on diagnostic surface 303 and connected to circuitry on layer 302 by down via 319a and up via 320a.

In use, sample solution containing the analyte(s) of interest is pumped into inlet 370 and through channel 321 to sample well 322a, until it is stopped by passive valves 338a and 339a. Pumping pressure may be provided by a syringe pump or other pumping device. A volume of sample solution sufficient to fill sample well 322a is followed by a larger volume of buffer, which is pumped into inlet 370 immediately after the sample solution. As buffer enters sample well 322a, one portion of the sample solution moves into ELISA circuit 324a and another portion of sample solution moves into mixing module 323a. Passive valve 329a causes sample to flow preferentially into side channel 326 of mixing module 323a, until it encounters passive valve 328, and passive valves 340a, 341a, 342a, and 343a cause fluid to flow preferentially down channel 330a and into read well 310a until it encounters passive valves 344a, 345a, 346a, and 347a. Capture antibodies recognizing the analyte of interest in the sample are immobilized in read well 310a. The sample must be incubated in this well for the time required by the immunological assay to ensure thorough binding.

It is critical that the volume of sample fluid loaded into the system is just sufficient to fill side channel 323a and read well 310a, so that once these structures are filled, sample solution in sample well 322a has been replaced by buffer solution. It is also critical that the strengths of the passive valves are such that the sample fluid will fill side channel 323a and read well 310a without entering other portions of the microfluidic circuitry, to ensure correct distribution of sample solution.

After side channel 323a and read well 310a have been filled, pumping additional buffer into channel 321 causes buffer to flow into either ELISA circuit 324a or mixing circuit 323a, depending on the relative strengths of valves 329 and 240a. When buffer flows into mixing circuit 323a, the volume of sample in side channel 326 is mixed with buffer as described in connection with FIGS. 25A-25D, and further in tortuous channel 327a that leads to sample well 322b. Passive valves 338b and 339b stop the flow of diluted sample after sample well 322b is filled.

Following a sufficient incubation period, during which sample is incubated in read well 310a, a volume of buffer must be pushed through main channel 330a and read well 310a to wash away unbound sample. Passive valve 344a must be overcome to let the sample fluid move into waste well 335a, while buffer moves into read well 310a. Next, buffer flows into side channel 334a. Valve 340a at the inlet to side channel 334a must have a strength less than any of valves 345a, 346a, or 347a at the outlet of read well 310a, and less than valve 341a at the start of side channel 332a, so that once read well 310a has been filled and washed, fluid flows preferentially into channel 334a and through conjugate well 330a. Conjugate well 330a contains deposited conjugate that has been lyophilized in situ or deposited in a bead form during the manufacture of this device. Upon contact with buffer, the conjugate is resuspended to form a conjugate-containing buffer solution, a process which occurs instantly. As buffer enters channel 334a, air escapes via air duct 350a, which connects to the atmosphere (either indirectly, as shown, or indirectly). Channel 334a preferably has a larger diameter than channel 330a, so that when both channels are filled with fluid, fluid flows preferentially in channel 334a to ensure that all of the conjugate is dissolved and carried to read well 310a. Once channel 334a has filled, conjugate-containing buffer solution moves into read well 310a, pushing rinse buffer solution past passive valve 345a and into waste well 336a, until it is stopped by passive valve 356a. Buffer containing conjugate is incubated in read well 310a for a defined period, resulting in the binding of the conjugate to the captured, immobilized analyte. Additional buffer is injected through inlet 370 to wash away unbound conjugate from the read well, moving it into waste well 337a. Passive valve 357a has a higher strength than passive valve 341a, so once waste well 337a is filled, buffer solution moves past passive valve 341a and into side channel 332a, where it rehydrates substrate in well 331a. Air duct 354a provides for the escape of air as buffer flows into side channel 332a. The diameter of channel 332a is larger than those of side channel 334a and main channel 330a, to insure that buffer flows preferentially through channel 332a to move all of the substrate into read well 310a. As buffer containing substrate moves into read well 310a, the previous contents of read well 310a are pushed past passive valve 347a and into waste well 338a. Sufficient time is allowed for a signal to develop, which is then detected and quantified by standard laboratory instrumentation. The layers of the device may be disassembled to interrogate signal from the read wells (i.e., from diagnostic surface 303), or the signal may be detected through diagnostic surface 303, providing that the detected signals can pass through it. It is preferred that the spacing between adjacent read wells is compatible with existing lab instrumentation.

The dilution steps carried out in each of mixing circuits 323a-323d result in serial dilution of the sample solution with buffer. A portion of the serially diluted sample solution from each of sample wells 322b-322e moves into each of ELISA circuits 324b-324e, respectively, in which the process described above is performed for each diluted sample. Appropriate selection of passive valve strengths and channel diameters permit the movement of fluid through particular portions of the fluid circuit to be finely controlled.

The methods of manufacturing multi-layered structures and fluid circuit components to form three-dimensional microfluidic circuits disclosed herein can be used to form various microfluidic structures and devices, of which the specific examples provided herein are merely exemplary. The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

List of References:

Anderson, J. R., D. T. Chiu, R. J. Jackman, O. Cherniavskaya, J. C. McDonald, H. Wo, S. H. Whitesides, G. M. Whitesides, Fabrication of Topologically Complex Three-Dimensional Microfluidic Systems in PDMS by Rapid Prototyping, Anal. Chem. 2000, 72, 3158-3164

1. A multi-layered microfluidic device comprising:
a. a plurality of substantially planar layers assembled together in sealing relationship;
b. microfluidic structures lying in at least two planes corresponding to at least two said planar layers of said microfluidic device; and
c. at least one microfluidic structure passing through one or more adjacent planar layers and providing fluid communication between microfluidic structures in different planes;
wherein said microfluidic structures comprise one or more channels, wells, dividers, mixers, valves, air ducts, or air vents; and wherein at least one of said plurality of planar layers has a hydrophobic surface.

2. The microfluidic device of claim 1, further comprising at least one active element selected from the group consisting of heating elements, electrodes, sensors, mixing elements, and active valves.

3. The microfluidic device of claim 2, wherein said active element comprises a mixing element selected from the group consisting of piezoelectric transducers, pneumatically actuated, operated bladders, and hydraulically actuated bladders.

4. The microfluidic device of claim 2, wherein said active element comprises a sensor selected from the group consisting of optical sensors, pressure transducers, flow transducers, and temperature sensors.

5. The microfluidic device of claim 1, wherein said at least one layer is formed of a hydrophobic material.

6. The microfluidic device of claim 1, wherein said at least one layer is formed of a non-hydrophobic base material, and said hydrophobic surface is formed by a hydrophobic coating on said non-hydrophobic base material.

7. The microfluidic device of claim 1, wherein said layers are aligned in an alignment frame prior to being assembled together.

8. The microfluidic device of claim 1, each said layer comprises at least two alignment holes formed there through, and wherein said layers are aligned by rods passing through said alignment holes.

9. The microfluidic device of claim 1, wherein at least two of said layers are assembled together in sealing relationship by being clamped together.

10. The microfluidic device of claim 9, wherein a fluid-tight seal between said at least two layers is obtained by providing a compressible gasket layer between non-compressible layers.

11. The microfluidic device of claim 9, wherein a fluid-tight seal between said at least two layers is obtained by providing hydrophobic surfaces at the interface between said two layers.

12. The microfluidic device of claim 1, wherein at least two of said layers are assembled together in sealing relationship with an adhesive.

13. The microfluidic device of claim 12, wherein said adhesive is releasable from at least one of said at least two layers.

14. The microfluidic device of claim 1, wherein the seal between at least two of said layers can be released to allow said at least two layers to be separated.

15. The microfluidic device of claim 14, wherein said device can be separated between said at least two layers into a disposable portion and a reusable portion.

16. The microfluidic device of claim 15, wherein one of said layers is a glass slide.

17. The microfluidic device of claim 15, wherein one of said layers is a microtiter plate.

18. The microfluidic device of claim 15, wherein at least one of said layers comprises at least one region having biomolecules immobilized thereon.

19. The microfluidic device of claim 1, wherein said planar layers are formed of hydrophobic base material.

20. The microfluidic device of claim 1, wherein at least one said valves is a passive valve.

21. The microfluidic device of claim 1, wherein at least one said valves is a remote valve.

22. The microfluidic device of claim 1, wherein microfluidic structures in one said plane are formed through the entire thickness of at least one layer, so that the boundaries of the microfluidic structures are formed by said at least one layer, and upper and lower surface are formed by adjacent layers.

23. The microfluidic device of claim 1, wherein at least a portion of the microfluidic structures in one said plane are formed in a surface of at least one said layer but do not pass through the entire thickness of the layer.

24. A multi-layered microfluidic device comprising:
a. a plurality of substantially planar layers assembled together in sealing relationship;
b. microfluidic structures lying in at least two planes corresponding to at least two said planar layers of said microfluidic device; and
c. at least one microfluidic structure passing through one or more adjacent planar layers and providing fluid communication between microfluidic structures in different planes;
wherein at least a portion of said microfluidic structures lying in said at least two planes are formed in a surface of at least one said layer but do not pass through the entire thickness of said layer, and wherein said microfluidic structures in said at least two planes and passing through one or more planar layers comprise at least one passive valve and at least one additional microfluidic structure selected from the group consisting of channels, wells, dividers, mixers, valves, air ducts, and air vents.

25. The microfluidic device of claim 24, further comprising at least one active element selected from the group consisting of heating elements, electrodes, sensors, mixing elements, and active valves.

26. The microfluidic device of claim 25, wherein said active element comprises a mixing element selected from the group consisting of piezoelectric transducers, pneumatically actuated, operated bladders, and hydraulically actuated bladders.

27. The microfluidic device of claim 25, wherein said active element comprises a sensor selected from the group consisting of optical sensors, pressure transducers, flow transducers, and temperature sensors.

28. The microfluidic device of claim 24, wherein at least one layer has a hydrophobic surface.

29. The microfluidic device of claim 28, wherein said at least one layer is formed of a hydrophobic material.

30. The microfluidic device of claim 28, wherein said at least one layer is formed of a non-hydrophobic base material, and said hydrophobic surface is formed by a hydrophobic coating on said non-hydrophobic base material.

31. The microfluidic device of claim 24, wherein at least two of said layers are assembled together in sealing relationship by being clamped together.

32. The microfluidic device of claim 31, wherein a fluid-tight seal between said at least two layers is obtained by providing a compressible gasket layer between non-compressible layers.

33. The microfluidic device of claim 31, wherein a fluid-tight seal between said at least two layers is obtained by providing hydrophobic surfaces at the interface between said two layers.

34. The microfluidic device of claim 24, wherein at least two of said layers are assembled together in sealing relationship with an adhesive.

35. The microfluidic device of claim 34, wherein said adhesive is releasable from at least one of said at least two layers.

36. The microfluidic device of claim 24, wherein the seal between at least two of said layers can be released to allow said at least two layers to be separated.

37. The microfluidic device of claim 36, wherein said device can be separated between said at least two layers into a disposable portion and a reusable portion.

38. The microfluidic device of claim 36, wherein one of said layers is a glass slide.

39. The microfluidic device of claim 36, wherein one of said layers is a microtiter plate.

40. The microfluidic device of claim 36, wherein at least one of said layers comprises at least one region having biomolecules immobilized thereon.

41. The microfluidic device of claim 24, wherein at least one of said valves is a remote valve.

42. The microfluidic device of claim 24, wherein microfluidic structures in at least one said plane are formed through the entire thickness of at least one layer, so that the boundaries of the microfluidic structures are formed by said at least one layer, and upper and lower surface are formed by adjacent layers.

43. A multi-layer microfluidic device for performing a biochemical reaction including a heating step, comprising:
a. a plurality of substantially planar layers assembled together;
b. at least one sample inlet formed in at least one said layer;
c. at least one thermal reaction well in fluid communication with said sample inlet;
d. at least one read well in fluid communication with said thermal reaction well;
and
e. at least one active valve located between said thermal reaction well and said read well to control flow of fluid between said thermal reaction well and said read well.

44. The multi-layer microfluidic device of claim 43 further comprising a heating element, wherein said heating element is formed in a different layer than said at least one thermal reaction well and is configured to provide heating to said thermal reaction well.

45. The multi-layer microfluidic device of claim 43, wherein said layers are clamped together.

46. The multi-layer microfluidic device of claim 45, wherein fluid-tight connections between layers are obtained by providing a compressible gasket layer between non-compressible layers.

47. The multi-layer microfluidic device of claim 45, wherein fluid-tight connections between layers are obtained by providing hydrophobic surfaces at said junctions.

48. The multi-layer microfluidic device of claim 47, wherein said hydrophobic surfaces are surfaces of hydrophobic base material.

49. The multi-layer microfluidic device of claim 47, wherein said hydrophobic surfaces are formed by hydrophobic coatings on non-hydrophobic base material.

50. A method of performing DNA processing in a multi-layer microfluidic device, comprising the steps of:
a. loading a solution containing a DNA sample of interest into said multi-layer microfluidic device;
b. distributing said solution into at least one thermal reaction well in said microfluidic device, said at least one thermal reaction well being provided with additional materials required for amplifying a specific DNA sequence of interest;
c. closing a valve downstream of said least one thermal reaction well to block the downstream movement of gas or liquid from said at least one thermal reaction well,
d. heating solution and additional materials in said at least one thermal reaction well in a manner sufficient to produce amplification of said specific DNA sequence of interest if it is present in the DNA sample of interest in said thermal reaction well;
e. opening said valve downstream of at least one said thermal reaction well;
f. washing contents of said at least one thermal reaction well out of said thermal reaction well, through said channel downstream of said thermal reaction well and into a corresponding read well; and
g. detecting the presence or absence of DNA in said read well.

51. The method of claim 50 adapted for performing PCR analysis, wherein said DNA solution comprises PCR cocktail without primers, wherein said additional materials comprise primer pairs specific for said specific DNA sequence of interest, and wherein said step of heating solution and additional materials in said at least one thermal reaction well comprises performing thermal cycling.

52. The method of claim 50 adapted for performing LCR analysis, wherein said step of heating solution and additional materials in said at least one thermal reaction well comprises an isothermal heating step.

53. The method of claim 50 adapted for performing RCA analysis, wherein said step of heating solution and additional materials in said at least one thermal reaction well comprises an isothermal heating step.

54. A method of performing a biochemical reaction in a multi-layer microfluidic device, comprising the steps of:
a. loading a solution into said multi-layer microfluidic device;
b. distributing said solution to at least one thermal reaction well in said microfluidic device;
c. closing a valve downstream of said at least one thermal reaction well to block the downstream movement of gas or liquid from said thermal reaction well;
d. heating said at least one thermal reaction well in the manner required for performing the biochemical reaction of interest;
e. opening said valve downstream of said at least one thermal reaction well;
f. washing contents of each said thermal reaction well out of each said thermal reaction well and into a corresponding downstream read well; and
g. detecting the presence or absence of a product of said biochemical reaction in said read well.

55. A three-dimensional microfluidic device for performing a binding reaction to detect an analyte of interest in a sample, comprising:
a. a plurality of substantially planar layers assembled in sealing relationship;
b. at least one inlet for receiving a sample solution in which the analyte of interest may be present;
c. a read well downstream of said inlet and containing a binding moiety adapted to bind said analyte of interest;
d. at least one waste well downstream of said read well for receiving fluid washed from said read well;
e. at least one passive valve for temporarily stopping the flow of fluid to retain fluid within said read well; and
f. at least one passive valve for at least temporarily stopping the flow of fluid to retain fluid within said waste well.

56. The three-dimensional microfluidic device of claim 55, wherein said inlet, read well, waste well, and passive valves are located in at least two different planes corresponding to two different planar layers of said microfluidic device.

57. A three-dimensional microfluidic device for performing ELISA to detect an analyte of interest in a sample, comprising:
a. a plurality of substantially planar layers;
b. at least one ELISA circuit having components formed in at least two of said layers, comprising:
i. a main channel adapted to receive a sample solution in which an analyte of interest may be present;
ii. a read well in fluid communication with said main channel and containing immobilized capture antibody specific for said analyte of interest;
iii. a conjugate well in fluid communication with said main channel and said read well, and containing a quantity of conjugate comprising antibody specific for said analyte of interest conjugated to an enzyme;
iv. a substrate well in fluid communication with said main channel and said read well, and containing a quantity of enzyme substrate capable of reacting with said enzyme to produce a detectable reaction product; and
v. a plurality of passive valves for directing the flow of fluid through said main channel, said read well, said conjugate well, and said read well in sequence to deliver, in order, sample solution, conjugate, and substrate to said read well.

58. The three-dimensional microfluidic device of claim 57, further comprising:
a. at least one additional ELISA circuit having components formed in at least two of said layers, comprising:
i. a main channel adapted to receive a sample solution in which an analyte of interest may be present;
ii. a read well in fluid communication with said main channel and containing immobilized capture antibody specific for said analyte of interest;
iii. a conjugate well in fluid communication with said main channel and said read well, and containing a quantity of conjugate comprising antibody specific for said analyte of interest conjugated to an enzyme;
iv. a substrate well in fluid communication with said main channel and said read well, and containing a quantity of enzyme substrate capable of reacting with said enzyme to produce a detectable reaction product; and
v. a plurality of passive valves for directing the flow of fluid through said main channel, said read well, said conjugate well, and said read well in sequence to deliver, in order, sample solution, conjugate, and substrate to said read well;
b. a first sample well located upstream of all additional sample wells and adapted to receive undiluted sample injected into said microfluidic device;
c. at least one additional sample well adapted to receive diluted sample from an upstream sample well; and
d. at least one mixing circuit positioned between each said additional sample well and an upstream sample well, said mixing circuit configured to mix sample from said upstream sample well with a diluent to form a diluted sample solution that is collected in said at least one additional sample well;
wherein sample solution from said first sample well is delivered to said at least one ELISA circuit and diluted sample solution from said at least one additional sample well is delivered to said at least one additional ELISA circuit, wherein each said ELISA circuit is used to detect an analyte of interest in said sample solution or a dilution of said sample solution

59. A three-dimensional microfluidic device for processing hybridization solution and to delivering it to the surface of a microarray slide, comprising:
a. a plurality of substantially planar layers assembled in sealing relationship;
b. an inlet channel through which at least a first portion of said hybridization solution may be loaded into the device;
c. microfluidic processing circuitry downstream of said inlet channel, comprising at least one component selected from the group consisting of: a well containing a reagent or other component of said hybridization solution to be combined with said first portion of said hybridization solution, a separation column for performing a separation step on at least a portion of said hybridization solution, a mixing circuit for mixing at least a portion of said hybridization solution with a diluent, and a branch circuit for dividing at least a portion of said hybridization solution among two or more channels;
d. at least one passive valve for regulating the flow of said hybridization solution through said microfluidic processing circuitry; and
e. a via channel for delivering at least a portion of said hybridization solution to the surface of the microarray slide;
wherein in use said microarray slide is assembled to said three-dimensional microfluidic device in sealing relationship so that at least one hybridization chamber is formed at the interface between said microarray slide and said three-dimensional microfluidic device, and wherein said via channel is in fluid communication with said hybridization chamber.

60. A three-dimensional microfluidic structure comprising:
a. a plurality of substantially planar layers assembled in sealing relationship;
b. microfluidic circuitry formed in at least two planes defined by said planar layers;
c. at least one microscale channel formed in a plane defined by at least one said layer; and
d. a passive valve comprising a short, abrupt narrowing within said at least one microscale channel;
wherein the interior surfaces of said channel and said passive valve are hydrophobic.

61. The three-dimensional microfluidic structure of claim 60, wherein said layers are formed of hydrophobic material.

62. The three-dimensional microfluidic structure of claim 60, wherein said layers are formed of non-hydrophobic base material with a hydrophobic coating.

63. A three-dimensional microfluidic structure comprising:
a. a plurality of substantially planar layers assembled in sealing relationship;
b. microfluidic circuitry formed in at least two planes defined by said planar layers;
c. at least one microscale channel formed through at least one said layer and providing fluid communication between microfluidic circuitry in at least two different planes defined by said planar layers; and
d. a passive valve comprising a short, abrupt narrowing within said at least one microscale channel.

64. The three-dimensional microfluidic structure of claim 63, wherein the interior surfaces of said channel and said passive valve are hydrophobic.

65. The three-dimensional microfluidic structure of claim 63, wherein said channel comprises aligned openings in at least three layers of said microfluidic structure, and wherein said passive valve is formed by at least one layer of said at least three layers in which said opening has a smaller cross-sectional area than said openings in others of said at least three layers.

66. The three-dimensional microfluidic structure of claim 63, wherein said channel comprises aligned openings in at least first and second layers of said microfluidic structure, wherein said first layer has an opening with a narrow section and a wide section, wherein said narrow section is narrower than the opening in said second layer, and wherein said first and second layers are assembled together such that said narrow section is position adjacent said second layer, and wherein said passive valve comprises said narrow section.

67. A three-dimensional microfluidic structure comprising:
a. a plurality of substantially planar hydrophobic layers assembled in sealing relationship; and
b. a well formed within said microfluidic structure, comprising a plurality of aligned holes in a plurality of adjacent layers.

68. A three-dimensional microfluidic structure comprising:
a. a plurality of substantially planar layers assembled in sealing relationship; a mixing circuit;
b. a mixing circuit formed within said three-dimensional structure comprising:
i. a first channel;
ii. a branch point downstream of said first channel at which said first channel branches into a main channel and a side channel;
iii. a first passive valve located downstream of said branch point on said main channel;
iv. a junction downstream of said branch point where said side channel rejoins said main channel;
v. a second passive valve located on said side channel just upstream of said junction, wherein said second passive valve is stronger than said first passive valve; and
vi. an outlet channel downstream of said junction.

69. The three-dimensional microfluidic structure of claim 68, wherein said mixing circuit comprises components formed in at least two different planes corresponding to at least two said planar layers.

70. A three-dimensional microfluid structure adapted for performing serial dilution of a sample, comprising:
a. a plurality of substantially planar layers assembled in sealing relationship; a mixing circuit;
b. a first mixing circuit formed within said three-dimensional structure comprising:
i. a first inlet channel;
ii. a branch point downstream of said first channel at which said first inlet channel branches into a first main channel and a first side channel;
iii. a first passive valve located downstream of said branch point on said main channel;
iv. a first junction downstream of said branch point where said first side channel rejoins said first main channel;
v. a second passive valve located on said first side channel just upstream of said first junction, wherein said second passive valve is stronger than said first passive valve; and
vi. a first outlet channel downstream of said junction;
c. at least one additional mixing circuit formed within said three-dimensional structure downstream of said first mixing circuit, comprising:
i. a second inlet channel downstream of said first outlet channel;
ii. a second branch point downstream of said second inlet channel at which said second inlet channel branches into a second main channel and a second side channel;
iii. a third passive valve located downstream of said second branch point on said second main channel;
iv. a second junction downstream of said branch second point where said second side channel rejoins said second main channel;
v. a fourth passive valve located on said second side channel just upstream of said second junction, wherein said fourth passive valve is stronger than said third passive valve; and
vi. a second outlet channel downstream of said second junction.

71. A method of mixing two fluids in a microfluidic structure, comprising the steps of:
a. injecting a quantity of a first fluid into the first channel of the mixing circuit of claim 69;
b. injecting a quantity of a second fluid into said first channel behind said second fluid, wherein said first fluid is diverted into said side channel by said first passive valve as it is pushed into said mixing circuit by said second fluid, and wherein said quantity of said first fluid is just sufficient to fill said side channel up to said second passive valve;
c. injecting additional second fluid into said first channel at a pressure sufficient to overcome said first passive valve to move first fluid into said main channel until it reaches said junction; and
d. injecting additional second fluid into said first channel to move said first fluid out of said second channel, past said junction, whereupon said first fluid combines with said second fluid in said outlet channel downstream of said junction.

72. A three-dimensional microfluidic branching circuit comprising:
a. a plurality of substantially planar layers assembled in sealing relationship;
b. an inlet channel passing through at least a first layer;
c. a primary branch channel formed in a second layer adjacent said first layer, wherein said inlet channel intersects said primary branch channel at its central region;
d. two primary via channels passing through a third layer adjacent said second layer, wherein one of said primary via channels intersects said primary branch channel at each of its ends;
e. two secondary branch channels formed in a fourth layer adjacent said third layer, wherein each of said via channels intersects one of said secondary branch channels at its central region;
f. four secondary via channels passing through a fifth layer adjacent said fourth layer, wherein one of said secondary via channels intersects each said secondary branch channel at each of its ends;
wherein said two primary via channels have smaller cross sectional areas than said primary branch channel, and wherein said four secondary via channels have smaller cross-sectional areas than said primary via channels.

73. A three-dimensional microfluidic branching circuit comprising:
a. a plurality of substantially planar layers assembled in sealing relationship;
b. an inlet channel passing through at least a first layer;
c. a branched channel formed in a second layer adjacent said first layer, wherein said inlet channel communicates with a central region of said branched channel, and wherein said branched channel has a plurality of arms extending outward from said central region;
d. a plurality of outlet channels formed in a third layer adjacent said second layer, each said outlet channel communicating with the end of one of said plurality of arms of said branched channel;
wherein each of said outlet channels provides a greater resistance to fluid flow than do said arms of said branched channel, thereby causing fluid entering said branched channel to fill all of said arms before entering any of said outlet channels.

74. A three-dimensional microfluidic structure comprising:
a. a plurality of substantially planar layers assembled in sealing relationship;
b. a microfluidic circuit including microfluidic structures lying in at least two planes corresponding to at least two said planar layers of said microfluidic device, said microfluidic circuit comprising:
i. a main channel;
ii. a side channel branching off of said main channel at a branch point;
iii. a first passive valve located in said side channel just downstream of said branch point;
iv. at least one microfluidic structure located downstream of said branch point in fluid communication with said main channel, said microfluidic structure comprising a well or a channel;
v. a second passive valve located downstream of said microfluidic structure;
wherein said first passive valve has a strength sufficient to cause fluid first entering said main channel under pressure to flow preferentially into said main channel rather than said side channel at said branch point; and wherein said second passive valve has a strength sufficient to divert fluid flow into said side channel after said main channel has been filled to said second passive valve.

75. The three-dimensional microfluidic structure of claim 74, wherein said side channel rejoins said main channel downstream of said branch point but upstream of said second passive valve; wherein said side channel comprises an air duct adjacent the point where said side channel rejoins said main channel; and wherein said side channel has a diameter sufficiently greater than that of said main channel that when said main channel and said side channel are filled with fluid, additional fluid injected into said main channel flows preferentially through said side channel at said branch point.

76. The three-dimensional microfluidic structure of claim 74, wherein said main channel, said side channel, said first passive valve, said microfluidic structure, and said second passive valve lie in one of said a least two planes, and wherein said microfluidic circuit comprises at least one additional microfluidic structure lying in another of said at least two planes.
